(19) United States
(12) Patent Application Publication
(10) Pub. No.: US 2015/0347354 A1
(43) Pub. Date: Dec. 3, 2015

(54) DISCRETE SOURCE CODE TIMELINES

(71) Applicant: APPLE INC., Cupertino, CA (US)

(72) Inventor: Timothy Gene Hatcher, Manteca, CA (US)

(73) Assignee: APPLE INC., Cupertino, CA (US)

(21) Appl. No.: 14/291,398

(22) Filed: May 30, 2014

(51) Int. Cl. G06F 17/21; G06F 17/30

(52) U.S. Cl. CPC G06F 17/212; G06F 17/30905

(57) ABSTRACT

Instructions stored in tangible, non-transitory, computer readable medium executable by a computing device to display a webpage on a graphical user interface. The instructions include instructions to, when a first event on the webpage is detected, determine location of a first piece of code in the webpage source code that is executed to produce the first event. Based on the location, the first event may be grouped with a second event that is produced using a common resource (e.g., file). Grouping the first and second event allows a first graphical element, which describes time and duration of the first event, and a second graphical element, which describes time and duration of the second event, to be displayed under a common resource grouping on the graphical user interface.

### BACKGROUND

The present disclosure relates generally to a layout engine (e.g., a web browser engine), and more particularly, to processing source code for display on a graphical user interface of the layout engine.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Generally, a computing device may execute source code to provide various applications. To help illustrate, a web browser on a computing device may display a webpage by processing source code using a layout engine. For example, Safari, a web browser made available by Apple Inc., uses Webkit (e.g., a layout engine) to receive and process source code from a uniform resource locator (URL) to display a webpage. More specifically, a computing device, using the layout engine, may execute portions of the source code to generate events, which facilitates the display and/or interaction with the webpage.

Accordingly, to improve the design (e.g., debugging or troubleshooting) process of an application (e.g., a webpage), it would be beneficial to improve the organization and presentation of information relating to events that occur in the application.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure generally relates to improving a webpage design process. More specifically, information relating to events that occur on a webpage may be presented on a graphical user interface. In some embodiments, the information may include the location of a portion of the webpage source code that is executed to produce an event, a start time of the event, a stop time of the event, duration of the event, or any combination thereof. For example, a graphical element corresponding with an event may be displayed on an event timeline on the graphical user interface. More specifically, the graphical element may be displayed to indicate the start time, the stop time, and the duration of the event.

Additionally, to further improve the webpage design process, events that occur on the webpage may be grouped together to provide additional insight into the relationship between multiple events. In some embodiments, events may be grouped based on a common resource, such as a common file in the source code. To facilitate conveying the grouping of events, graphical elements corresponding with grouped events may be displayed on the timeline under one resource grouping.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of a computing device used to render a webpage, in accordance with an embodiment;

FIG. 2 is a block diagram of functional blocks of the computing device of FIG. 1 including a layout engine, in accordance with an embodiment;

FIG. 3 is a graphical user interface of the layout engine of FIG. 2, in accordance with an embodiment;

FIG. 4 is a graphical user interface of the layout engine of FIG. 2 displaying source code timelines, in accordance with an embodiment;

FIG. 5 is a graphical user interface of the layout engine of FIG. 2 displaying source code timelines, in accordance with an embodiment;

FIG. 6 is a flow diagram describing a process for displaying a graphical element on the graphical user interfaces of FIGS. 4 and 5, in accordance with an embodiment; and

FIG. 7 is a flow diagram describing a process for displaying a graphical element on a timeline on the graphical user interface of FIGS. 4 and 5, in accordance with an embodiment.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As mentioned above, a computing device may execute source code to provide various applications. For example, the applications provided may include games, such as Angry Birds, made available by Rovio Entertainment limited, or tools, such as Safari, made available by Apple Inc. To simplify the following discussion, the techniques below will be described in relation to executing webpage source code in a web browser (e.g., Safari). However, one of ordinary skill in the will be able to utilize the techniques described herein to improve the design process for any application utilizes source code divided into multiple resources.

Accordingly, referring to a web browser application, a layout engine may allow for the web browser on a computing device to display a webpage. More specifically, the computing device may receive source code from a target URL entered into the web browser. Using the layout engine, portions of the source code may be executed to generate events on the webpage. As used herein, “events” generally describe the processing of source code to display the webpage and/or the processing of source code to provide for the ability to interact with the webpage. For example, cascading style sheets (CSS) source code may be processed to describe presentation (e.g., look or formatting) of content on the webpage and JavaScript source code may be processed to provide the ability to interact with the webpage.

In other words, portions of the source code may be executed at various times to present the webpage in the web browser. For example, a first portion of the source code may be executed to evaluate a script and a second potion of the source code may be executed to install a timer. More specifically, the portions of the source code that are executed may depend at least in part on a user's interaction with the webpage. For example, when a user scrolls down, portions of the source code are executed to render areas of the webpage that were previously not displayed.

Accordingly, it would be beneficial to the design (e.g., debugging or troubleshooting) process of a webpage to provide information relating to when events occur during display and/or interaction with the webpage. More specifically, the occurrence of events along with information relating to the events may be presented on a graphical user interface displayed on a computing device. In some embodiments, the events may be presented on the graphical user interface as a linear list based on when each occurs. For example, when an event to invalidate a style is initiated at a first time is initiated, information relating to the event, such as the type of event, the portion of the source code that initiated the event, the start time of the event, and the duration of the event, may be presented on a list. Subsequently, an event to recalculate a style is initiated at a second time. When the event to recalculate the style is initiated, information relating to the event may be presented on the list below the event to invalidate a style. At a third time, the event to invalidate a style may again be initiated and information relating to the event may be presented on the list below the event to recalculate a style.

In other words, in a linear embodiment, information relating to an occurring event may be presented based only on when it is initiated. However, in other embodiments, it may be beneficial to group and/or selectively present information relating to an event (e.g., start time, duration, and location of source code) to further improve the design process of a webpage. For example, in some embodiments, when a first event is detected on a webpage, the computing device displaying the webpage may determine location of a first piece of code in source code of the webpage that is executed to produce the first event. Additionally, the computing device may group the first event with a second event that is produced using a common resource. As used herein, a “resource” is intended to describe an identifiable self-contained piece of information, such as a file or document. Accordingly, the first event and the second event may use a common resource when the executed code is part of the same file in the source code. Based on the grouping, a first graphical element and a second graphical element are displayed under a common resource grouping on the graphical user interface, such that the first graphical element describes time and duration of the first event and the second graphical element describes time and duration of the second event.

In other words, information relating to events that use a common resource may be grouped and displayed under a common grouping. In some embodiments, the common resource may be a particular file in the source code or a particular function that is used to facilitate the display or interaction with the webpage. For example, the common resource may be a file that contains portions of the source code related to rendering the webpage. Accordingly, as will be described in more detail below, presentation of information relating to events may be improved, which, in some embodiments, may allow a developer to easily analyze when and where events are occurring in context with other related events.

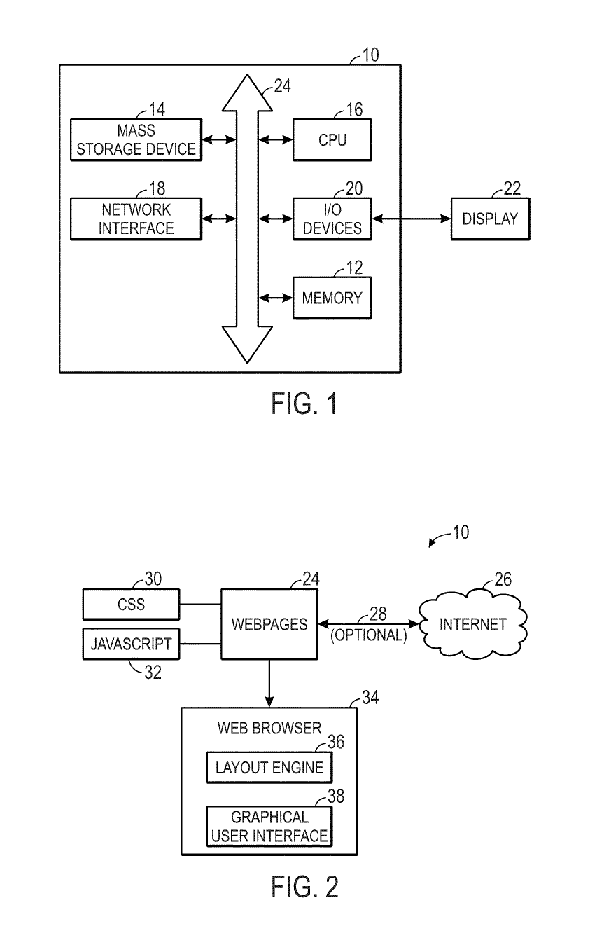

By way of introduction, a computing device 10 that may display a webpage is described in FIG. 1. Accordingly, the computing device 10 may be any type of electronic device, such as a laptop or desktop computer, a mobile phone, a digital media player, or the like, that can execute source code to facilitate display and/or interaction with a webpage. By way of example only, the computing device 10 may be a portable electronic device, such as a model of an iPod® or iPhone®, available from Apple Inc. of Cupertino, California. Additionally, the electronic device 10 may be a desktop or laptop computer, such as a model of a MacBook®, MacBook® Pro, MacBook Air®, iMac®, Mac® Mini, or Mac Pro®, available from Apple Inc. In other embodiments, computing device 10 may also be a model of an electronic device from another manufacturer.

To facilitate in its various functions, the computing device 10 may include various internal and/or external components. For example, as depicted, the computing device 10 includes memory 12, a mass storage device 14, a central processing unit (CPU) 16, a network interface 18, I/O devices 20, and a display 22. Those of ordinary skill in the art will appreciate that each of these components may include hardware elements (e.g., circuitry), software elements (e.g., instructions stored on a computer-readable medium), or both.

As will be described in more detail below, one function of the computing device 10 may include displaying a webpage. For example, in the depicted embodiment, a webpage may be displayed on display 22. More specifically, the display 22 may display a graphical user interface that includes the webpage. As such, the display 22 may be any suitable type of display, such as a liquid crystal display (LCD), plasma display, or an organic light emitting diode (OLED) display. In some embodiments, the display 22 may be an external display, such as an external monitor. Additionally or alternatively, the display 22 may be included in the computing device 10, such as in a portable electronic device.

To display the webpage, the computing device 10 may communicate the webpage to the display 22 via the I/O devices 20. More specifically, the I/O devices 20 may include ports that connect the computing device 10 to a variety of external devices, such as a power source, an audio output device (e.g., headset or headphones), or other electronic devices (e.g., handheld devices and/or computers, printers, projectors, external displays, modems, and docking stations). Accordingly, the I/O devices 20 may support any suitable interface type, such as a universal serial bus (USB) port, a serial connection port, an IEEE-1394 (FireWire) port, an Ethernet or modem port, a High-Definition Multimedia Interface (HDMI) port, a Video Graphics Array (VGA) port, a Digital Visual Interface (DVI) port, and/or an AC/DC power connection port.

Additionally, another function of the computing device 10 is providing for the ability to interact with a webpage. For example, in the depicted embodiment, user inputs via the I/O device 20 may instruct the computing device 10 to load a webpage or to run an animation on the webpage. Accordingly, the I/O devices 20 may include buttons, sliders, switches, control pads, keys, knobs, scroll wheels, keyboards, mice, touchpads, or some combination thereof. Additionally, in some embodiments, the display 22 may be provided in conjunction with a touch-sensitive mechanism (e.g., a touch screen) that provides user inputs. For example, a user may select or interact with a displayed graphical user interface (e.g., webpage) via the touch sensitive mechanism.

More specifically, the I/O device 20 may generate electrical signal to indicate the user inputs. The input signals may then be routed to the processor 16 for processing. As such, the computing device 10 may determine a user's interactions with the webpage, for example, when the user clicks on an animation.

More generally, the processor 16 may control operation of the computing device 10. For instance, the processor 16 may provide the processing capability to execute an operating system, programs, user and application interfaces, and any other functions of the computing device 10. Accordingly, as used herein, the processor 16 may include one or more microprocessors, such as one or more “general-purpose” microprocessors, one or more special-purpose microprocessors, one or more application-specific microprocessors (ASICs), or any combination thereof.

To facilitate controlling general operation of the computing device 10, the processor 16 may be coupled to the other components in the computing device 10 via one or more data buses 24. For example, the processor 16 may retrieve and execute instructions stored in a non-transitory, computer-readable medium, such as memory 12 or the mass storage device 14. Accordingly, the one or more data buses 24 may use various architectures, such as Peripheral Component Interconnect (PCI), Microchannel, SCSI, Industrial Standard Architecture (ISA), or Extended ISA (EISA) architectures.

More generally, the memory 12 and the mass storage device 14 may store information, such as data to be processed by the processor 16 and/or instructions executable by the processor 16. Accordingly, the memory 12 may include volatile memory, such as random access memory (RAM), or non-volatile memory, such as read-only memory (ROM). Additionally, the mass storage device 14 may include flash memory, a network drive, a hard drive, or any other optical, magnetic, and/or solid-state storage media, or some combination thereof.

As will be described in more detail below, the computing device 10 may execute source code to facilitate display and/or interaction with a webpage. In some embodiments, the webpage source code may be received from a uniform resource locator (URL) address via a network, such as the Internet. Accordingly, the computing device also may also include a network interface 18 to provide for network connectivity. In some embodiments, the network interface 18 may provide wireless networking over a wireless 802.11 standard or any other suitable networking standard, such as a local area network (LAN) or a wide area network (WAN), such as an Enhanced Data Rates for GSM Evolution (EDGE) network or a 3G data network.

More specifically, when the source code is executed, events on the webpage may occur and be displayed on the webpage. To help illustrate, the processing on webpage source code is described as function blocks in FIG. 2. Generally, each of these function blocks may represent functions performed by the computing device 10, for example, by executing instructions stored in memory 12 or mass storage device 14 with the processor 16.

As depicted, the computing device 10 may receive a webpage 24 from the Internet 26 via a network connection 28. In other embodiments, the webpage 24 may be local to the computing device 10. As described above, the webpage 24 may include source code that when executed instructs the computing device 10 regarding how to display the webpage 32 and what interactions to provide/allow on the webpage 24. Accordingly, source code may include cascading style sheet (CSS) files 30 that describe the presentation (e.g., layout) of the webpage 24 and JavaScript files 32 that describe interactions with the webpage 24. More specifically, the JavaScript files 32 may describe changes in content displayed on the webpage 24 based on user inputs. As used herein, each CSS file 30, each JavaScript file 33, as well as any other file included in the source code, such as an image file, an XML HTTP request (XHR) file, an HTML file, or an XML file, is referred to as a resource.

Based on the source code, the computing device 10 may present the webpage 24 in a web browser 34. In some embodiments, the web browser may be Safari, made available by Apple Inc., Firefox, made available by Mozilla Corp., Internet Explorer, made available by Microsoft Corp., or Chrome, made available by Google Inc. Accordingly, as depicted, the web browser 34 generally includes a layout engine 36 and a graphical user interface 38. For example, Safari includes the WebKit layout engine.

Generally, the web browser 34 may use the layout engine 36 to render the webpage 24. More specifically, based on the webpage source code, the layout engine 36 may generate a graphical representation of the webpage 32 and process user interactions with the webpage 32. For example, the layout engine 36 may process the CSS files 30 to determine layouts, colors, and fonts to use on the webpage 32. Additionally, the layout engine 36 may process the JavaScript files 32 to handle links, forms, cookies, client-side scripting, plug-in loading, and the like on the webpage 32. In some embodiments, the layout engine 36 utilizes a display engine and/or a graphics driver to facilitate rendering certain aspects of the webpage 32, such as animations. The rendered webpage 24 may then be displayed via a graphical user interface 38 on the display 22. As such, the graphical user interface 38 provides the ability for a user to view and/or interact with the webpage 32.

In addition to rendering a webpage 32, the layout engine 36 may provide additional functions used in the design of the webpage 32. For example, the layout engine 36 may provide development tools that facilitate prototyping, optimizing, and debugging a webpage 32. One such development tool is Web Inspector, made available by Apple Inc. More specifically, to facilitate design of the webpage 32, the layout engine 36 may present information relating to events that occur on the webpage 32. As described above, the techniques described herein may be utilized to improve the design process for any application. Accordingly, in other embodiments, the development tool may include Xcode or Instruments, made available by Apple Inc., or any other suitable development tool.

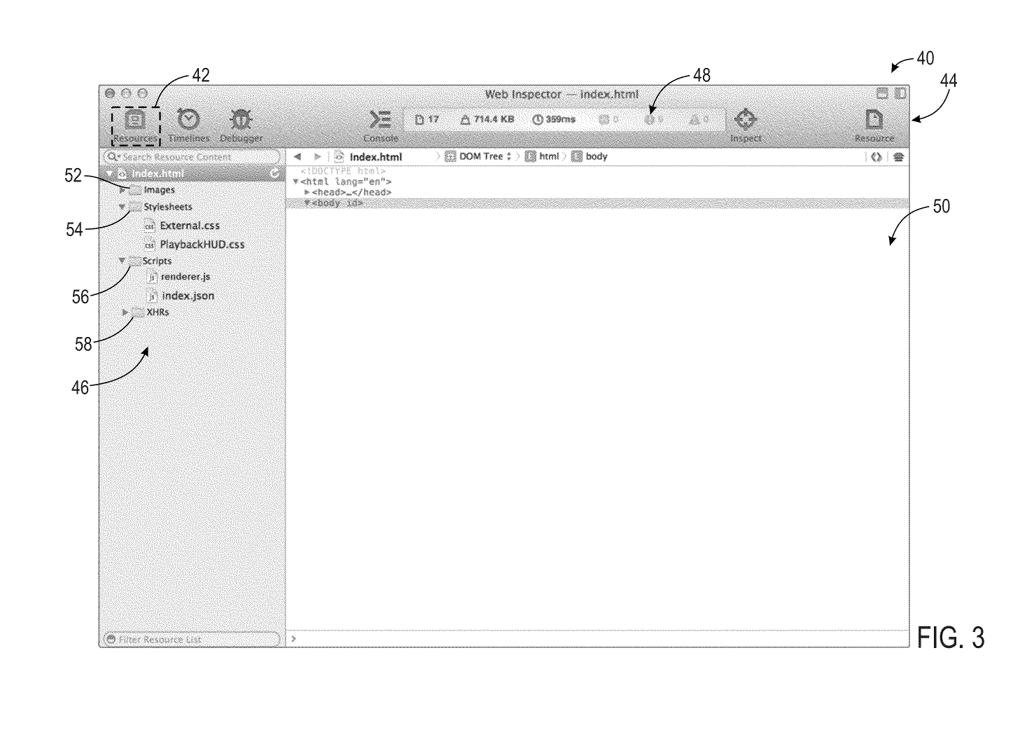

As described above, an event occurs when portions of the webpage source code are executed to display an element on the webpage 32 or when portions of the webpage source code are executed to facilitate user interaction with the webpage 32. Accordingly, to improve the webpage design process, event information may be presented to a user on the graphical user interface 38. To help illustrate, embodiments of the graphical user interface 38 that present information related to the index.html webpage are described in FIGS. 3-5. For example, FIG. 3 describes a resource window 40 that is displayed when the resource button 42 is selected from the toolbar 44. As depicted, the resource window 40 includes a resource navigation sidebar 46, an activity viewer 48, and a source code browser 50 that displays the source code (e.g., document object model) of the webpage 32.

More specifically, the activity viewer 48 may display a summary of useful information relating to the webpage 32, such as the number of total resources, the total file size of all the resources, and the time elapsed until a load event. For example, in the depicted embodiment, the activity view 48 indicates that the index.html webpage has a total of 17 resources, a total resource file size of 714.4 KB, and an elapsed time of 359 ms.

Additionally, the resource navigation sidebar 46 may display the various resources included in the webpage source code based on type. More specifically, the resources may be grouped under folders, such as an Image folder 52 that includes image files, a Stylesheets folder 54 that includes CSS files, a Scripts folder 56 that includes JavaScript files, and a XHRs folder 58 that includes XHR files. For example, in the depicted embodiment, an External.css resource and a PlaybakHUD.css resource are listed under the Stylesheets folder 54. Similarly, a renderer.js resource and an index.json resource are listed under the JavaScript folder 56. As described above, each resource may be a file that includes portions of the webpage source code. Accordingly, when executed, events on the webpage 32 are produced.

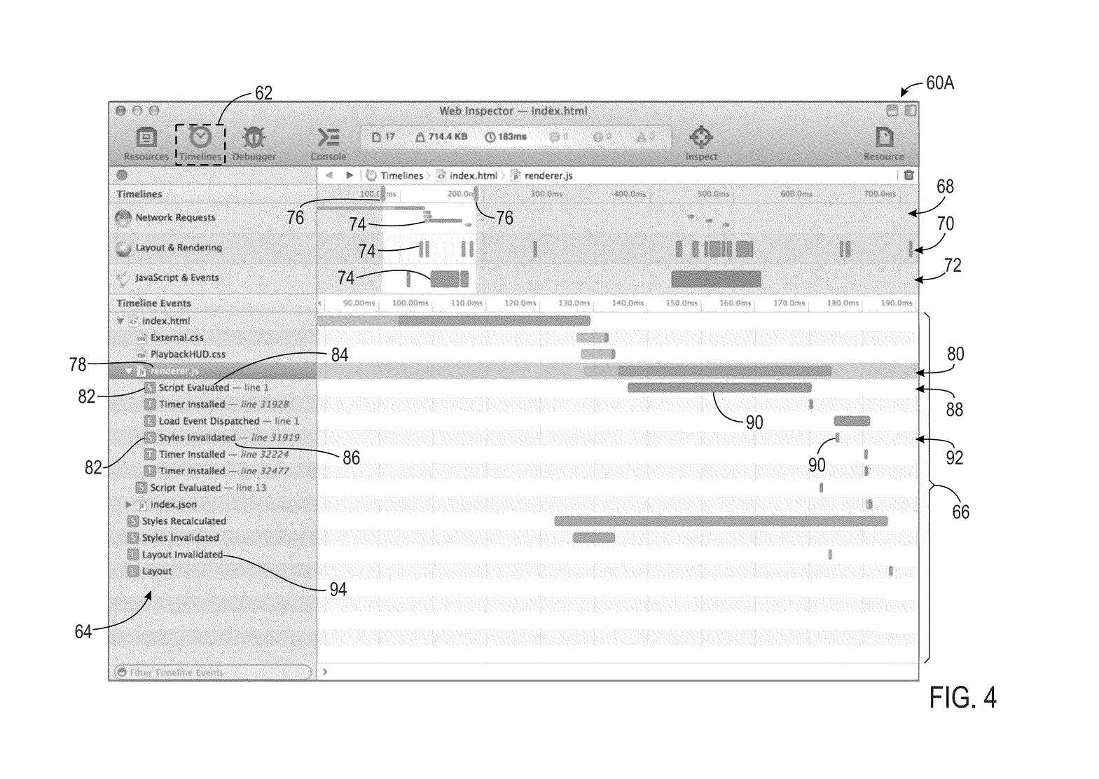

In the depicted embodiment, to display additional information relating to events that occur on the webpage 32, a timeline window 60A may be displayed by clicking the timeline button 62 on the toolbar 44, as depicted in FIG. 4. However, as can be appreciated, the timeline window 60A may be accessed in any suitable manner, for example, as the homepage of the development tool. As depicted, the timeline window 60A is divided between an event side bar 64, event timelines 66, and high level timelines, which includes a Network Requests timeline 68, a Layout & Rendering timeline 70, and a JavaScript timeline 72. More specifically, the Network Requests timeline 68 may indicate when network requests are taking place, for example, when the computing device 10 requests a resource. Additionally, the Layout & Rending timeline 70 may indicate when layout and rendering events are taking place, for example, when the layout engine 36 processes a CSS file 30. Similarly, the JavaScript timeline 72 may indicate when JavaScript events are taking place, for example, when the layout engine 36 processes a JavaScript file 32. In other embodiments, the high level timelines may include other timelines, such as an energy timeline, a canvas and WebGL rendering timeline, or a document object model (DOM) timeline.

More specifically, the high level timelines 68, 70, and 72 may indicate when network request and events are taking place by displaying a graphical element. For example, the Network Requests timeline 68 may display a horizontal bar 74 to indicate when network requests are taking place. Similarly, the Layout & Rending timeline 70 may display a horizontal bar 74 to indicate when layout and rendering events are taking place and the JavaScript timeline 72 may display a horizontal bar 74 to indicate when JavaScript events are taking place. In some embodiments, the horizontal bars 74 displayed in each timeline may be different colors to better differentiate the timelines. For example, the horizontal bars 74 on the Network Requests timeline 68 may be blue, the horizontal bars on the Layout & Rending timeline 70 may be red, and the horizontal bars on the JavaScript timeline 72 may be purple.

A more detailed view of the network requests and events that occur may be presented in the event sidebar 64 and the event timelines 66. More specifically, the event timelines 66 and the event sidebar 64 may describe network requests and events that occur during a selectable portion of time. For example, sliders 76 are moved along the high level timelines 68, 70, and 72 to select a period of time for which to present a more detailed view of network requests and events in the event sidebar 64 and the event timelines 66. In other words, the sliders 76 are adjustable to select a time period of interest. In the depicted embodiment, the sliders 76 are set such that the event sidebar 64 and the event timelines 66 describe network requests and events between approximately 80 ms and 190 ms.

More specifically, information for network requests associated with each resource, such as when a resource was requested, the latency of the request, and the download time of the resource, may be presented. For example, the network request associated with the renderer.js resource 78 may be described by resource timeline 80. More specifically, the resource timeline 80 indicates that the renderer.js resource was requested at approximately 128 ms, began downloading at approximately 135 ms, and completed downloading at approximately 174 ms. As described above, it is again emphasized that as used herein a network request is distinct from an event because as used herein an event is described as execution of source code to facilitate display and/or interaction with a webpage.

Information relating to each event, such as the type of event, the name of the event, and the location of source code that is executed to produce the event, may be presented in the event side bar 64. In some embodiments, the type of event may be indicated by the color of the event icons 82 displayed next to the name of the event. For example, in the depicted embodiment, the colors used by the event icons 82 may correspond with the colors of the graphical elements displayed on the high level timelines 68, 70 and 72. In other words, the event icon 82 for a layout and rendering event may be red and the event icon 82 for a JavaScript event may be purple. For example, in the depicted embodiment, the event icon 82 for the Script Evaluated event 84 may be purple to indicate that it is a JavaScript event and the event icon 82 for the Styles Invalidated event 86 may be red to indicate that is a layout and rendering event.

Additionally, the event icons 82 may provide a quick indication of the name of the event. For example, in the depicted embodiment, the event icon 82 includes the first letter of the name of the event. More specifically, the event icon 82 for the Script Evaluated event 84 is “S” and the event icon 82 for the Styles Invalidated event 86 is also “S.”

Furthermore, the event sidebar 64 may provide the location of the source code including the line and/or column number. For example, in the depicted embodiment, the event sidebar 64 indicates that the source code executed to produce the Script Evaluated event 84 is located in line 1 and the source code executed to produce the Styles Invalidated event 86 is located in line 31919. In fact, in some embodiments, when a user clicks on the event name, the user may be taken directly to the location in the source code.

The location may additionally include the resource (e.g., file) that the source code is located in. More specifically, events that are produced using the same resource may be grouped together and displayed under the common resource. For example, the Script Evaluated event 84 and the Styles Invalidated event 86 may both be included in the renderer.js resource. Accordingly, as depicted, the Scripts Evaluated event 84 and the Styles Invalidated event 86 are both displayed under the renderer.js heading 78. As depicted, other events that are included in the renderer.js resource are also grouped and displayed under the renderer.js heading 78.

Additionally, as described above, a corresponding event timeline 66 may be displayed next to each event that occurs during the selected period (e.g., 80 ms to 190 ms). More specifically, each event timeline 66 may display graphical elements to indicate when an event begins, when the event stops, and the duration of the event. For example, the Script Evaluated timeline 88 may display a horizontal bar 90 to indicate when the Script Evaluated event 84 is taking place. As such, in the depicted embodiment, the Script Evaluated timeline 88 indicates that the Script Evaluated event 84 began at approximately 137 ms, ended at approximately 172 ms, and lasted a duration of approximately 35 ms. Similarly, the Style Invalidated timeline 92 indicates that the Styles Invalidated event 86 began at approximately 174 ms, ended at approximately 175 ms, and lasted a duration of approximately 1 ms. In some embodiments, the horizontal bars 90 displayed in each event timeline 66 may be different colors to better differentiate the timelines. For example, the horizontal bar 90 on the Scripts Evaluated timeline 88 may be purple to indicate that it is a JavaScript event and the horizontal bar 90 on the Styles Invalidated timeline 92 may be red to indicate that it is a layout and rendering event.

Furthermore, since the event timelines 66 are displayed next to the corresponding events, the event timelines 66 are also grouped and displayed by resource. For example, in the depicted embodiment, the Script Evaluated timeline 88 and the Styles Invalidated timeline 92 are grouped and displayed under the renderer.js heading 78. As depicted, the event timelines 66 corresponding with other events included in the renderer.js resource are also grouped and displayed under the renderer.js heading 78.

Additionally, in some embodiments, the display of event timelines 66 grouped under a common resource can be toggled between a collapsed view and an expanded view. As depicted, the depicted embodiment is in an expanded view because each of the individual event timelines 66 grouped under the renderer.js heading 78 are separately displayed. From the expanded view, the event timelines 66 may be toggled into a collapsed view, for example, to save display space. In some embodiments, when the event timelines 66 are collapsed, each of the event timelines 66 may be superimposed onto the resource timeline. For example, in the depicted embodiment, the Script Evaluated timeline 88, the Styles Invalidated timeline 92, as well as the other event timelines 66 may be superimposed on the resource timeline 80 corresponding with the renderer.js resource. In other embodiments, each of the individual event timelines 66 may be hidden when in a collapsed view and displayed in the expanded view.

As illustrated by the above example, information relating to an event is not merely presented based on when the event is initiated. Instead, related events may be grouped based on what resource (e.g., file) they use, which provides for the ability to present event information for the related events together. Comparatively, when event information is presented merely based on when the event occurs, a user may have to scour through multiple lines of information to find all of the event information related to a common resource. To help illustrate, in the depicted embodiment, the Script Evaluated event 84 is initiated at approximately 137 ms and the Styles Invalidated event 86 is initiated at approximately 174 ms. In between these two events, a Layout Invalidated event 94 is initiated at approximately 173 ms. Accordingly, in an embodiment where the event information is presented based merely on when the event is initiated, information relating to the Layout Invalidated event 94 will be presented between information relating to the Script Evaluated event 84 and the Styles Invalidated event 86. As such, if a user is trying to debug events related to the renderer.js resource, the user would have to recognize to skip over the information relating to the Layout Invalidated event 94.

Accordingly, to improve the design process of a webpage, the present disclosure allows the information related to a common resource to be grouped and displayed together. For example, as in the above example, type, name, location of source code, start time, stop time, and duration for each event that uses the renderer.js resource is grouped and displayed together. As such, the design process of a webpage may be improved because information related to a single resource may be presented together. For example, the user that is trying to debug events related to the renderer.js resource may simply look under the renderer.js heading 78. In other words, the presentation of event information is streamlined because a user may easily determine where to look for desired event information.

Moreover, in some embodiments, event information may be sorted and/or filtered to present desired information. More specifically, event be presented based on various sorting and/or filtering parameters, such as duration of the event or the resource used to produce the event. For example, a user may request the display of only event information for events that use a specific resource or set of resources. Additionally, a user may request the display of only event information for events that last longer than 2 ms. Furthermore, a user may request the display of event information based on location (e.g., line or column number) within a resource. In other words, in some embodiments, the presentation of event information may further be streamlined by presenting only event information desired by the user and/or event information in a specifiable order.

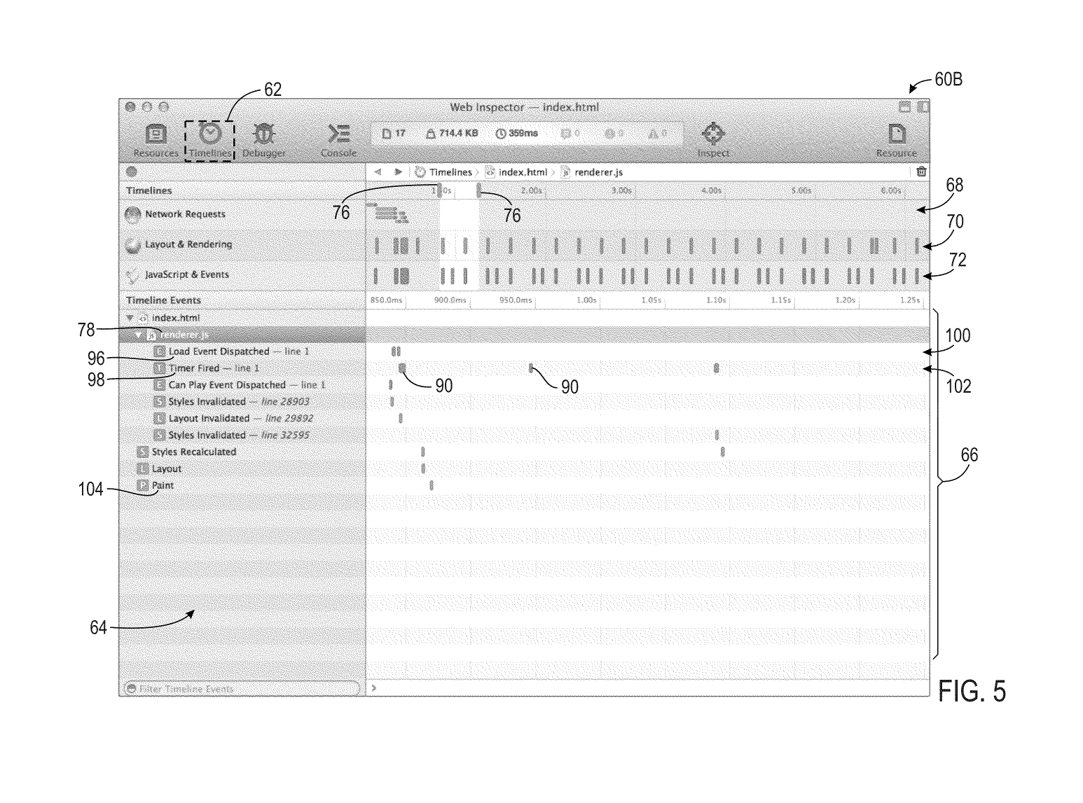

To further improve the webpage design process, embodiments of the present disclosure may consolidate event information relating to repeating or timed events. To help illustrate, a timeline window 60B is described in FIG. 5. As depicted, the event sidebar 64 and the event timelines 66 present information related to events that occur on the webpage 32 between approximately 825 ms and 1250 ms. As in timeline window 60A, events that occur may be grouped and displayed based on resource. For example, in the depicted embodiment, a Load Event Dispatched event 96 and a Timer Fired event 98 both use the renderer.js resource and thus are grouped and displayed under the renderer.js 78 heading in the event sidebar 64.

Accordingly, a Load Event Dispatched timeline 100, which describes when the Load Event Dispatched event 96 occurs, and a Timer Fired timeline 102, which describes when the Timer Fired Event 98 occurs, are also grouped and displayed under the renderer.js heading 78. More specifically, as depicted, each event timeline 66 may indicate each instance the corresponding event occurs. For example, the Load Event Dispatched timeline 100 indicates that the Load Event Dispatched event 96 occurs between approximately 842 ms to 843 ms and again between approximately 844 ms to 845 ms. Similarly, the Timer Fired timeline 102 indicates that the Timer Fired event 98 occurs between approximately 845 ms to 850 ms, between approximately 945 ms to 946 ms, and again between approximately 1090 ms to 1092 ms.

As illustrated by the above example, information relating to an event is not merely presented based on when the event is initiated. Comparatively, when event information is presented merely based on when the event occurs a user may have to scour through multiple lines of information to each occurrence of an event. To help illustrate, in the depicted embodiment, the Paint event 104 is initiated at approximately 870 ms and the first occurrence of the Timer Fired event 98 is initiated at 845 ms and the second occurrence of the Timer Fired event 98 is initiated at approximately 945 ms. Accordingly, in an embodiment where the event information is presented based merely on when the event is initiated, information relating to the Paint event 104 will be presented between information relating to the first and the second occurrence of the Timer Fired event 98. As such, if a user is trying to debug events related to the Timer Fired event 98, the user would have to skip over information relating to the Paint event 104 among others.

Accordingly, to improve the design process of a webpage, the present disclosure allows the information related to a repeating event to be grouped and displayed together. For example, as in the above example, start time, stop time, and duration for each occurrence of the Timer Fired event 98 is grouped and displayed together. As such, the design process of a webpage may be improved because information related to a single event may be presented together. For example, the user that is trying to debug events related to the Timer Fired event 98 may simply look on the Timer Fired timeline 102. In fact, in some embodiments, the filtering and/or sorting capability described above may be extended to repeating events. For example, a user may request the display of only event information related to repeating timed events. In other words, in some embodiments, the presentation of event information may further be streamlined because a user may easily determine where to look for desired event information, the user may be presented only with desired event information, and the user may be presented with event information in a desired order.

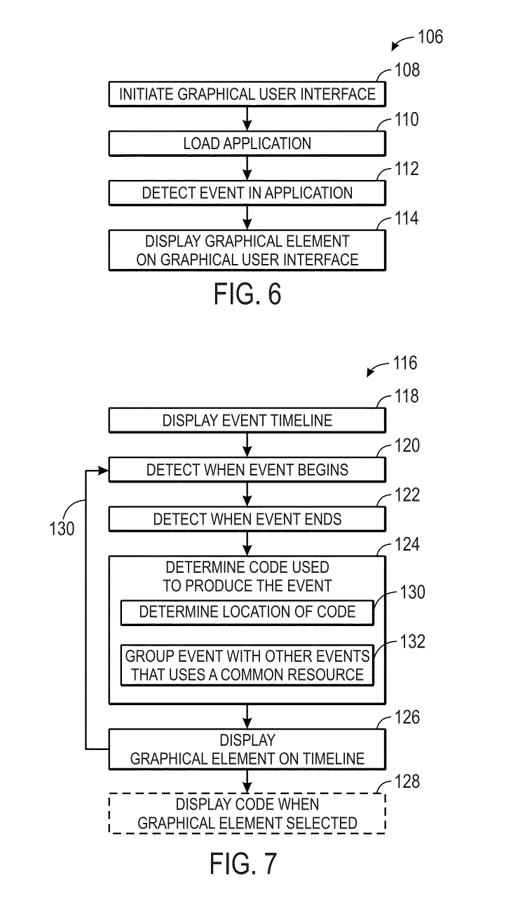

One embodiment of a process 106 that may be used to display the timeline windows 60 is described in FIG. 6. Generally, the process 106 include initiating a graphical user interface (process block 108), loading a webpage (process block 110), detecting an event on the webpage (process block 112), and displaying a graphical element on the graphical user interface (process block 114). More specifically, process 106 may be implemented with the computing device 10 by executing instructions stored in memory 12 or mass storage device 14 with the processor 16.

Accordingly, the computing device 10 may initiate a graphical user interface that displays information related to events (process block 108). In some embodiments, the graphical user interface may include a resource window 40 or a timeline window 60. For example, as described above, the resource window 40 presents the webpage source code and the timeline window 60 presents information such as event type, name, location, start time, stop time, and duration.

When an application (e.g., webpage 32) is loaded (process block 110), the computing device 10 may detect when an event occurs in the application (process block 112). For example, a webpage 32 may be loaded when a user types in the URL of the webpage 32 into the web browser 34. In other embodiments, an application may be loaded when a user instructs the application to start. Additionally, the computing device 10 may detect when an event occurs in application by monitoring the output by the processor 16. For example, the computing device 10 may detect when an event occurs on the webpage 32 by monitoring the layout engine 36. More specifically, the processor 16 may identify whenever application source code is executed to facilitate display and/or interaction with the application.

Once the event is detected, the computing device 10 may display a graphical element on the graphical user interface to present information relating to the event (process block 114). For example, as described above, the computing device 10 may display source code executed to produce the event in the resource window 40. Additionally, as described above, the computing device 10 may display event timelines 66 that indicate the start time, stop time, and duration of the event in the timeline window 60.

To better illustrate the presentation of event timelines 66 in the timeline window 60, process 116 is described in FIG. 7. Generally, process 116 includes displaying an event timeline (process block 118), detecting when an event begins (process block 120), detecting when the event ends (process block 122), determining code used to produce the event (process block 124), and displaying a graphical element on the timeline (process block 126). Process 116 also optionally includes displaying the code when the graphical element is selected (process block 128). In some embodiments, process 116 may be implemented with the computing device 10 by executing instructions stored in memory 12 or mass storage device 14 with the processor 16. To simplify discussion, process 116 will be described in relation to a web browser application. However, one of ordinary skill in the art will be able to apply the described techniques to any suitable application.

Accordingly, the computing device 10 may display an event timeline 66 on the graphical user interface 38 (process block 118). More specifically, the computing device 10 may instruct the web browser 34 to output a graphical user interface 38 that includes the event timeline 66 for display on the display 22. For example, the processor 16 may retrieve a graphical representation of the event timeline 66 from the memory 12 or mass storage device 14 and transmit the graphical representation to the display 22 via the I/O devices 22.

As described above, the event timeline 66 may be presented in a timeline window 60, which allow for the ability to display multiple event timelines 66. Additionally, as described above, the event timeline 66 allows a user (e.g., a webpage developer) to determine information relating to an event, such as the start time of the event, the stop time of the event, the duration of the event, and the number of occurrences of the event.

As such, the computing device 10 may detect when an event begins (process block 120) and detect when the event ends (process block 122). More specifically, the computing device 10 may detect when the event begins based on when the layout engine 36 begins to process source code that produces the event, for example, by monitoring the result of source code executed by the processor 16. In a similar manner, the computing device 10 may detect when the event ends based on when the layout stops processing source code that produces the event. Additionally, since the start time and the stop time of the event is known, the computing device 10 may also determine the duration of the event. More specifically, the duration may be determined based on the time difference between the start time and the stop time of the event.

When the event is detected, the computing device 10 may additionally determine the source code processed by the layout engine 36 to produce the event (process block 124). In some embodiments, this may include determining the location of the source code (process block 130) and grouping the event with other events that use a common resource (process block 132). For example, the computing device 10 may determine the line, column, and resource (e.g., file) where the source code is located.

Additionally, based on the resource where the source code is located, the computing device 10 may also group the event with other events that are produced when source code in the common resource are executed. For example, referring to the above example, the computing device 10 may determine that the Styles Invalidated event 86 is produced when the layout engine 36 processes a fist portion of code included in the renderer.js resource and may also determine that the Script Evaluated event 84 is produced when the layout engine 36 processes a second portion of code included in the renderer.js resource. As such, Load Event Dispatched event 96 and the Timer Fired event 98 may be grouped together. Furthermore, in some embodiments, the computing device 10 may determine what event information to present based on various filtering parameters and in what order to present the information based on various sorting parameters.

To facilitate communicating such information, the computing device 10 may display a graphical element on the event timeline 66 (process block 126). In some embodiments, the computing device 10 may display a horizontal bar 90 on the event timeline 66 to indicate information, such as the start time of the event, the stop time of the event, and the duration of the event. For example, referring again to the above example, the horizontal bar 90 on the Script Evaluated timeline 88 may indicate that the Script Evaluated event 84 began at approximately 137 ms, ended at approximately 172 ms, and lasted a duration of approximately 35 ms.

Additionally, in some embodiments, the computing device 10 may display multiple event timelines 66 under a common heading to indicate that the events are produced using a common resource. For example, referring to the above example, the Script Evaluated timeline 88 and the Styles Invalidated timeline 92 are both displayed under the renderer.js heading 78 to indicate that the Script Evaluated event 84 and the Styles Invalidated event 86 both use the renderer.js resource (e.g., a common resource). In some embodiments, the source code that is executed to produce the event may be displayed when the graphical element (e.g., horizontal bar 90) is selected (process block 128)

Furthermore, the computing device 10 may detect if the event begins again (arrow 130). More specifically, if the event occurs again, the computing device 10 may again gather information relating to the subsequent occurrence, such as the start time, stop time, and duration. As described above, such information may be consolidated with the information determined relating to the prior occurrence and displayed together. In some embodiments, this may include displaying an additional horizontal bar 90 on the event timeline 66. For example, referring to the above example, a first horizontal bar between approximately 845 ms to 850 ms may be displayed on the Timer Fired timeline 102 to indicate information relating to the first occurrence of the Timer Fired event 98. Additionally, a second horizontal bar between approximately 945 ms to 946 ms may be displayed on the Timer Fired timeline 102 to indicate information relating to the second occurrence of the Timer Fired event 98.

Accordingly, the technical effects of the present disclosure include improving the application design process by presenting information related to events that occur in the application in a logical and consolidated manner. More specifically, in some embodiments, information relating to event may be grouped, filtered, sorted, and displayed based on use of a common resource (e.g., file). By grouping events that use a common resource, a user (e.g., a developer) may better analyze the resource. For example, if the user is trying to debug the resource, information relating to event that are produced based on the resource will be presented together. Additionally, in some embodiments, information relating to a repeating or timed event may be consolidated and displayed together. By consolidating event information relating to a repeating or timed event, a user may better analyze the event. For example, if the user is trying to debug the event, information relating to each occurrence of the event will be presented together.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A tangible, non-transitory, computer readable medium storing instructions executable by a processor of a computing device configured to display a webpage on a graphical user interface, wherein the instructions comprise instructions to, when a first event on the webpage is detected:
determine, using the processor, a location of a first piece of code in source code of the webpage that is executed to produce the first event, wherein the location comprises a resource in which the first piece of code is located; and
group, using the processor, the first event with a second event that is produced using the same resource, such that a first graphical element and a second graphical element are displayed under a common resource grouping on the graphical user interface, wherein the first graphical element is configured to describe time and duration of the first event and the second graphical element is configured to describe time and duration of the second event.

2. The tangible, non-transitory, computer readable medium of claim 1, wherein the instructions comprises instructions to, when the second event is detected:
determine a location of a second piece of code in the source code of the webpage that is executed to produce the second event, wherein the location comprises the resource in which the second piece of code is located.

3. The tangible, non-transitory, computer readable medium of claim 1, wherein the instructions comprises instructions to:
display the first graphical element on a first event timeline, wherein the first graphical element indicates start time, stop time, and duration of the first event; and
display the second graphical element on a second event timeline, wherein the second graphical element indicates start time, stop time, and duration of the second event.

4. The tangible, non-transitory, computer readable medium of claim 1, wherein the instructions comprise instructions to:
detect a third event that is produced using the first piece of the source code; and
display the first graphical element and a third graphical element on an event timeline, wherein the third graphical element is configured to describe time and duration of the third event.

5. The tangible, non-transitory, computer readable medium of claim 1, wherein the instructions comprise instructions to:
determine when the first event begins; and
determine when the first event ends, wherein the first graphical element is displayed based at least in part on when the first event begins and when the first event ends.

6. The tangible, non-transitory, computer readable medium of claim 1, wherein the location of the first piece of code comprises line, column, and resource in which the first piece of code is located.

7. The tangible, non-transitory, computer readable medium of claim 1, wherein the resource is a JavaScript file, a Cascading Style Sheets file, an image file, an XML HTTP request file, an HTML file, a XML file, or any combination thereof.

8. The tangible, non-transitory, computer readable medium of claim 1, wherein the first event is a layout and rendering event or a JavaScript event.

9. A computing device configured to display a webpage comprising:
a processor configured to detect events that occurs on the webpage and to identify a location of webpage source code that is executed to produce the events; and
a graphical user interface configured to:
display a first event timeline that describes a time interval when the webpage source code is executed;
display a second event timeline that describes the time interval, wherein the first event timeline and the second event timeline are displayed based at least in part on the location of webpage source code that is executed to produce the first event and location of webpage source code that is executed to produce the second event;
display a first graphical element on the first event timeline to indicate information relating to the first event; and
display a second graphical element on the second event timeline to indicate information relating to the second event.

10. The computing device of claim 9, wherein the location of webpage source code that is executed to produce the first event comprises a line where the source code is located, a column where the source code is located, and a resource that the source code is included in.

11. The computing device of claim 9, wherein the graphical user interface is configured to display the first event timeline and the second event timeline under a common resource heading to indicate that the location of the webpage source code executed to produce the first event and the location of the webpage source code executed to produce the second event is a common resource.

12. The computing device of claim 9, wherein the processor is configured to detect a subsequent occurrence of the first event; and
the graphical user interface is configured to display a third graphical element on the first event timeline to indicate information related to the subsequent occurrence of the first event.

13. The computing device of claim 9, wherein the information related to the first and second events comprises start time, stop time, and duration.

14. The computing device of claim 9, wherein the graphical user interface is configured to display an event sidebar, wherein the event sidebar is configured to provide event information next to each event timeline.

15. The computing device of claim 14, wherein the event information provided in the event sidebar comprises an event name, an event location, an event type, an event icon, or any combination thereof.

16. The computing device of claim 9, wherein the first graphical element and the second graphical element are horizontal bars, wherein the horizontal bars are colored to indicate type of the events.

17. The computing device of claim 9, wherein the first event timeline and the second event timeline are displayed to indicate the location of webpage source code that is executed to produce the first event and the location of webpage source code that is executed to produce the second event.

18. A method comprising:
detecting, using a processor in a computing device that displays a webpage, a first occurrence of an event that facilitates display or interaction with the webpage;
displaying, on a display of the computing device, a first graphical element on an event timeline to indicate information related to the first occurrence of the event;
detecting, using the processor, a second occurrence of the event; and
displaying, on the display, a second graphical element on the event timeline to indicate information related to the second occurrence of the event.

19. The method of claim 18, comprising displaying the event timeline based at least in part on a location of a portion of webpage source code that is executed to produce the event.

20. The method of claim 18, wherein the information related to the first occurrence of the event comprises start time of the first occurrence, stop time of the first occurrence, and duration of the first occurrence, and the information related to the second occurrence of the event comprises start time of the second occurrence, stop time of the second occurrence, and duration of the second occurrence.

21. The method of claim 18, comprising:
detecting, using the processor, another subsequent occurrence of the event; and
displaying, on the display, a third graphical element on the event timeline to indicate information related to the subsequent occurrence of the event.

22. The method of claim 18, wherein the first graphical element and the second graphical element are horizontal bars on the event timeline.

23. The method of claim 18, wherein the event is programmed in source code of the webpage to occur multiple times as a repeating event.

24. A method comprising:
executing, using a processor in a computing device that displays an application, application source code to produce an event that facilitates display or interaction with the application;
displaying, using a display of the computing device, a graphical element that indicates information relating to the event, wherein where the graphical element is displayed is based at least in part on what file comprises the application source code.

25. The method of claim 24, wherein the graphical element is a horizontal bar on an event timeline, wherein the horizontal bar and the event timeline are displayed under a resource heading and the horizontal bar is configured to indicate type of the event.

26. The method of claim 24, wherein the graphical element is an event icon displayed on an event sidebar, wherein the event icon is displayed under a resource heading and is configured to indicate type of the event.

27. The method of claim 24, wherein the event is a layout and rendering event or a JavaScript event.

28. The method of claim 24, wherein the file is a JavaScript file, a Cascading Style Sheets file, an image file, an XML HTTP request file, an XML file, an HTML file, or any combination thereof.
